(19) United States
(12) Patent Application Publication
(10) Pub. No.: US 2024/0257212 A1
(43) Pub. Date: Aug. 1, 2024

(54) SYSTEM AND METHOD FOR IMPROVING DIVERSIFICATION IN ONLINE ITEM RECOMMENDATIONS

(71) Applicant: Walmart Apollo, LLC, Bentonville, AR (US)

(72) Inventors: Zhihao Huang, San Jose, CA (US); Afroza Ali, Los Altos, CA (US); Abhimanyu Mitra, Cupertino, CA (US)

(21) Appl. No.: 18/103,237

(22) Filed: Jan. 30, 2023

(51) Int. Cl. G06Q 30/0601

(52) U.S. Cl. CPC G06Q 30/0631

(57) ABSTRACT

Systems and methods for improving diversification in online item recommendations are disclosed. In some embodiments, a disclosed method includes: receiving, from a computing device, a recommendation request seeking recommendations to be displayed on a webpage of a website to a user; obtaining user session data identifying website activities of users on the website; determining weights of a set of content elements associated with the website based on posterior distributions utilizing the user session data; modifying the weights by at least one predetermined parameter to generate updated weights based on contextual feature data of the set of content elements; generating, from the set of content elements, a ranked list of content elements as recommended content based on the updated weights of the set of content elements; and transmitting, to the computing device, the recommended content in response to the recommendation request.

### TECHNICAL FIELD

This application relates generally to item recommendations and, more particularly, to systems and methods for improving diversification in online item recommendations.

### BACKGROUND

Item recommendation tasks in e-commerce industry are essential to improve user experiences by recommending items to users. For example, a website may display item recommendations, and may further allow a customer to purchase recommended items. Some existing recommendation systems provide item recommendations to a user based on a search query submitted by the user, or based on an anchor item and historical transaction data of other users with respect to this anchor item.

When selecting the recommended items, existing methods focus on a direct optimization of a single metric, e.g. click through rate. But this single-metric based optimization method may not be comprehensive enough. For example, if an item is very popular based on recent transaction and click through data, existing method would recommend this popular item on a homepage of a retailer's website over and over again, regardless which user is visiting the homepage or how many times a user has refreshed the webpage. This is not good to discoverability and diversification of items on the website, which are critical features to the website especially in the long run.

### SUMMARY

The embodiments described herein are directed to systems and methods for improving diversification in online item recommendations.

In various embodiments, a system including a non-transitory memory configured to store instructions thereon and at least one processor is disclosed. The at least one processor is configured to read the instructions to: receive, from a computing device, a recommendation request seeking recommendations to be displayed on a webpage of a website to a user; obtain user session data identifying website activities of users on the website; determine weights of a set of content elements associated with the website based on posterior distributions utilizing the user session data; modify the weights by at least one predetermined parameter to generate updated weights based on contextual feature data of the set of content elements; generate, from the set of content elements, a ranked list of content elements as recommended content based on the updated weights of the set of content elements; and transmit, to the computing device, the recommended content in response to the recommendation request.

In various embodiments, a computer-implemented method is disclosed. The computer-implemented method includes: receiving, from a computing device, a recommendation request seeking recommendations to be displayed on a webpage of a website to a user; obtaining user session data identifying website activities of users on the website; determining weights of a set of content elements associated with the website based on posterior distributions utilizing the user session data; modifying the weights by at least one predetermined parameter to generate updated weights based on contextual feature data of the set of content elements; generating, from the set of content elements, a ranked list of content elements as recommended content based on the updated weights of the set of content elements; and transmitting, to the computing device, the recommended content in response to the recommendation request.

In various embodiments, a non-transitory computer readable medium having instructions stored thereon is disclosed. The instructions, when executed by at least one processor, cause at least one device to perform operations including: receiving, from a computing device, a recommendation request seeking recommendations to be displayed on a webpage of a website to a user; obtaining user session data identifying website activities of users on the website; determining weights of a set of content elements associated with the website based on posterior distributions utilizing the user session data; modifying the weights by at least one predetermined parameter to generate updated weights based on contextual feature data of the set of content elements; generating, from the set of content elements, a ranked list of content elements as recommended content based on the updated weights of the set of content elements; and transmitting, to the computing device, the recommended content in response to the recommendation request.

### BRIEF DESCRIPTION OF THE DRAWINGS

The features and advantages of the present invention will be more fully disclosed in, or rendered obvious by the following detailed description of the preferred embodiments, which are to be considered together with the accompanying drawings wherein like numbers refer to like parts and further wherein:

FIG. 1 is a network environment configured to improve diversification in online item recommendations, in accordance with some embodiments of the present teaching.

FIG. 2 is a block diagram of an item recommendation computing device, in accordance with some embodiments of the present teaching.

FIG. 3 is a block diagram illustrating various portions of an item recommendation system, in accordance with some embodiments of the present teaching.

FIG. 4 is a block diagram illustrating various portions of an item recommendation computing device, in accordance with some embodiments of the present teaching.

FIG. 5 illustrates a balance between explore and exploit in an explore-exploit model, in accordance with some embodiments of the present teaching.

FIG. 6 illustrates an example of a homepage including diversified item recommendations, in accordance with some embodiments of the present teaching.

FIG. 7 illustrates a process for providing diversified item recommendations, in accordance with some embodiments of the present teaching.

FIG. 8A illustrates exemplary impression percentages for different item categories based on an explore-exploit model, in accordance with some embodiments of the present teaching.

FIG. 8B illustrates exemplary impression percentages for different item categories based on a diversification model, in accordance with some embodiments of the present teaching.

FIG. 9A illustrates an exemplary item recommendation based on an explore-exploit model, in accordance with some embodiments of the present teaching.

FIG. 9B illustrates an exemplary item recommendation based on a diversification model, in accordance with some embodiments of the present teaching.

FIG. 10 illustrates exemplary impression percentages for different carousel modules based on an explore-exploit model and a diversification model, respectively, in accordance with some embodiments of the present teaching.

FIG. 11A illustrates exemplary recommended carousels based on an explore-exploit model, in accordance with some embodiments of the present teaching.

FIG. 11B illustrates exemplary recommended carousels based on a diversification model, in accordance with some embodiments of the present teaching.

FIG. 12 is a flowchart illustrating an exemplary method for improving diversification in online item recommendations, in accordance with some embodiments of the present teaching.

### DETAILED DESCRIPTION

This description of the exemplary embodiments is intended to be read in connection with the accompanying drawings, which are to be considered part of the entire written description. Terms concerning data connections, coupling and the like, such as “connected” and “interconnected,” and/or “in signal communication with” refer to a relationship wherein systems or elements are electrically and/or wirelessly connected to one another either directly or indirectly through intervening systems, as well as both moveable or rigid attachments or relationships, unless expressly described otherwise. The term “operatively coupled” is such a coupling or connection that allows the pertinent structures to operate as intended by virtue of that relationship.

In the following, various embodiments are described with respect to the claimed systems as well as with respect to the claimed methods. Features, advantages or alternative embodiments herein can be assigned to the other claimed objects and vice versa. In other words, claims for the systems can be improved with features described or claimed in the context of the methods. In this case, the functional features of the method are embodied by objective units of the systems.

In e-commerce, items can be recommended to users (e.g. online customers of a retailer) who are browsing a website online. There is a choice between exploiting content that is known to be effective and exploring new content to learn its effectiveness, when selecting content for recommendation. The explore-exploit choice is compounded when considering not only optimization in terms of business concerned metrics (e.g. click-through rate, add to cart rate, etc.), but also the diversification of recommended items. On one hand, considering solely metric-based optimization would keep showing the best performing items and ignore the remaining items. On the other hand, considering solely diversification, e.g. by random selection, the recommendation performance would be really bad in terms of business concerned metrics.

One goal of various embodiments in the present teaching is to increase the diversification while keeping the optimization, when recommending items online. In some embodiments, an item recommendation system integrates a diversification model into an explore-exploit framework to find a good balance between optimization and diversification.

In some embodiments, the item recommendation system can leverage a Thompson sampling based Bayesian model to optimize a metric like click-through rate (CTR), add-to-cart (A2C) rate, or conversion rate, to find popular items to be selected for online recommendation. The item recommendation system may increase the diversification of recommendation by re-ranking the popular items and/or exploring some not-so-popular items.

In some examples, the item recommendation system may increase context level diversification of the online recommendation. Given some additional contextual features, the item recommendation system diversify the item re-ranking accordingly. Some exemplary contextual features may include price, product type, and review rating for one or more items to be selected and ranked for online recommendation.

In some examples, the item recommendation system may increase item level diversification of the online recommendation. By increasing the variance of a posterior distribution, the item recommendation system can improve recommendation diversification globally. While the variance increase is controlled based on a predetermined parameter, the item recommendation system can improve exploration to some extent with a controlled cost of optimization capability. For example, when a user refreshes into another session, the item re-ranking may be different to some extent, due to the item level diversification.

The disclosed item recommendation system provides a solution to balance diversification and optimization on both contextual level and exploration level for online item recommendations. The system can improve diversification significantly without much loss in optimization, e.g. based on an explore-exploit algorithm with modifications to incorporate a diversification model and its hyperparameters. Evaluation of the hyperparameters based on simulations has proven a quantified impact and performance improvement of the diversification model. As such, the system can provide both diversified and popular recommendations, to help customers to make better purchase decisions with dynamic engagement and make easier the discovery of new or low-key products.

Furthermore, in the following, various embodiments are described with respect to methods and systems for improving diversification in online item recommendations. In some embodiments, a recommendation request is received, from a computing device, seeking recommendations to be displayed on a webpage of a website to a user. User session data identifying website activities of users on the website is obtained. Weights of a set of content elements associated with the website are determined based on posterior distributions utilizing the user session data. The weights are modified by at least one predetermined parameter to generate updated weights based on contextual feature data of the set of content elements. From the set of content elements, a ranked list of content elements are generated as recommended content based on the updated weights of the set of content elements. The recommended content is transmitted to the computing device in response to the recommendation request.

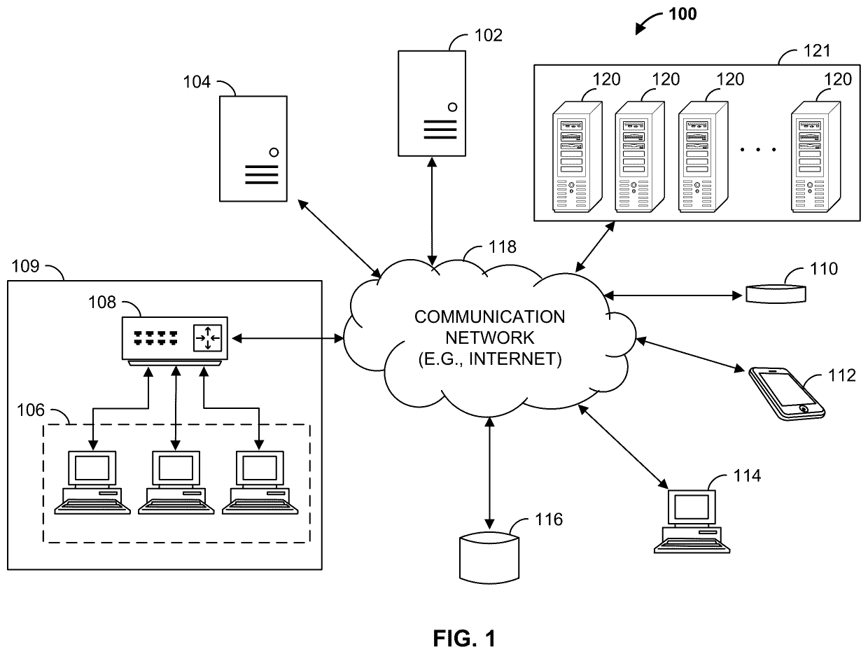

Turning to the drawings, FIG. 1 is a network environment 100 configured to improve diversification in online item recommendations, in accordance with some embodiments of the present teaching. The network environment 100 includes a plurality of devices or systems configured to communicate over one or more network channels, illustrated as a network cloud 118. For example, in various embodiments, the network environment 100 can include, but not limited to, an item recommendation computing device 102 (e.g., a server, such as an application server), a web server 104, a cloud-based engine 121 including one or more processing devices 120, workstation(s) 106, a database 116, and one or more customer computing devices 110, 112, 114 operatively coupled over the network 118. The item recommendation computing device 102, the web server 104, the workstation(s) 106, the processing device(s) 120, and the multiple customer computing devices 110, 112, 114 can each be any suitable computing device that includes any hardware or hardware and software combination for processing and handling information. For example, each can include one or more processors, one or more field-programmable gate arrays (FPGAs), one or more application-specific integrated circuits (ASICs), one or more state machines, digital circuitry, or any other suitable circuitry. In addition, each can transmit and receive data over the communication network 118.

In some examples, each of the item recommendation computing device 102 and the processing device(s) 120 can be a computer, a workstation, a laptop, a server such as a cloud-based server, or any other suitable device. In some examples, each of the processing devices 120 is a server that includes one or more processing units, such as one or more graphical processing units (GPUs), one or more central processing units (CPUs), and/or one or more processing cores. Each processing device 120 may, in some examples, execute one or more virtual machines. In some examples, processing resources (e.g., capabilities) of the one or more processing devices 120 are offered as a cloud-based service (e.g., cloud computing). For example, the cloud-based engine 121 may offer computing and storage resources of the one or more processing devices 120 to the item recommendation computing device 102.

In some examples, each of the multiple customer computing devices 110, 112, 114 can be a cellular phone, a smart phone, a tablet, a personal assistant device, a voice assistant device, a digital assistant, a laptop, a computer, or any other suitable device. In some examples, the web server 104 hosts one or more retailer websites. In some examples, the item recommendation computing device 102, the processing devices 120, and/or the web server 104 are operated by a retailer, and the multiple customer computing devices 110, 112, 114 are operated by customers of the retailer. In some examples, the processing devices 120 are operated by a third party (e.g., a cloud-computing provider).

The workstation(s) 106 are operably coupled to the communication network 118 via a router (or switch) 108. The workstation(s) 106 and/or the router 108 may be located at a store 109, for example. The workstation(s) 106 can communicate with the item recommendation computing device 102 over the communication network 118. The workstation(s) 106 may send data to, and receive data from, the item recommendation computing device 102. For example, the workstation(s) 106 may transmit data identifying items purchased by a customer at the store 109 to item recommendation computing device 102.

Although FIG. 1 illustrates three customer computing devices 110, 112, 114, the network environment 100 can include any number of customer computing devices 110, 112, 114. Similarly, the network environment 100 can include any number of the item recommendation computing devices 102, the processing devices 120, the workstations 106, the web servers 104, and the databases 116.

The communication network 118 can be a WiFi® network, a cellular network such as a 3GPP® network, a Bluetooth® network, a satellite network, a wireless local area network (LAN), a network utilizing radio-frequency (RF) communication protocols, a Near Field Communication (NFC) network, a wireless Metropolitan Area Network (MAN) connecting multiple wireless LANs, a wide area network (WAN), or any other suitable network. The communication network 118 can provide access to, for example, the Internet.

Each of the first customer computing device 110, the second customer computing device 112, and the Nth customer computing device 114 may communicate with the web server 104 over the communication network 118. For example, each of the multiple computing devices 110, 112, 114 may be operable to view, access, and interact with a website, such as a retailer's website, hosted by the web server 104. The web server 104 may transmit user session data related to a customer's activity (e.g., interactions) on the website. For example, a customer may operate one of the customer computing devices 110, 112, 114 to initiate a web browser that is directed to the website hosted by the web server 104. The customer may, via the web browser, view item advertisements for items displayed on the website, and may click on item advertisements, for example. The website may capture these activities as user session data, and transmit the user session data to the item recommendation computing device 102 over the communication network 118. The website may also allow the operator to add one or more of the items to an online shopping cart, and allow the customer to perform a “checkout” of the shopping cart to purchase the items. In some examples, the web server 104 transmits purchase data identifying items the customer has purchased from the website to the item recommendation computing device 102.

In some examples, the item recommendation computing device 102 may execute one or more models (e.g., algorithms), such as a machine learning model, deep learning model, statistical model, etc., to determine recommended items to advertise to the customer (i.e., item recommendations). The item recommendation computing device 102 may transmit the item recommendations to the web server 104 over the communication network 118, and the web server 104 may display advertisements for one or more of the recommended items on the website to the customer. For example, the web server 104 may display the recommended items to the customer on a homepage, a catalog webpage, an item webpage, a search results webpage, or a post-transaction webpage of the website (e.g., as the customer browses those respective webpages).

In some examples, the web server 104 transmits a recommendation request to the item recommendation computing device 102. The recommendation request may be sent together with a search query provided by the customer (e.g., via a search bar of the web browser), or a standalone recommendation request provided by a processing unit in response to the user's action on the website, e.g. interacting (e.g., engaging, clicking, or viewing) with one or more items, adding one or more items to cart, purchasing one or more items, opening or refreshing a homepage.

In one example, a customer selects an item on a website hosted by the web server 104, e.g. by clicking on the item to view its product description details, by adding it to shopping cart, or by purchasing it. The web server 104 may treat the item as an anchor item or query item for the customer, and send a recommendation request to the item recommendation computing device 102. In response to receiving the request, the item recommendation computing device 102 may execute the one or more processors to determine some recommended items that are related (e.g. substitute or complementary) to the anchor item. In some embodiments, the item recommendation computing device 102 may also determine some recommended items that are not so related to the anchor item to improve diversification, e.g. items with similar review ratings but different product types and different price ranges from the anchor item. The item recommendation computing device 102 may transmit some or all of the recommended items to the web server 104 to be displayed together with the anchor item to the customer.

In another example, a customer submits a search query on a website hosted by the web server 104, e.g. by entering a query in a search bar. The web server 104 may send a recommendation request to the item recommendation computing device 102. In response to receiving the request, the item recommendation computing device 102 may execute the one or more processors to first determine search results including items matching the search query, and then determine some recommended items that are related to one or more top items in the search results and/or some recommended items to improve diversification. The item recommendation computing device 102 may transmit the recommended items to the web server 104 to be displayed together with the search results to the customer.

The item recommendation computing device 102 is further operable to communicate with the database 116 over the communication network 118. For example, the item recommendation computing device 102 can store data to, and read data from, the database 116. The database 116 can be a remote storage device, such as a cloud-based server, a disk (e.g., a hard disk), a memory device on another application server, a networked computer, or any other suitable remote storage. Although shown remote to the item recommendation computing device 102, in some examples, the database 116 can be a local storage device, such as a hard drive, a non-volatile memory, or a USB stick. The item recommendation computing device 102 may store purchase data received from the web server 104 in the database 116. The item recommendation computing device 102 may also receive from the web server 104 user session data identifying events associated with browsing sessions, and may store the user session data in the database 116.

In some examples, the item recommendation computing device 102 generates training data for a plurality of models (e.g., machine learning models, deep learning models, statistical models, algorithms, etc.) based on historical user session data, purchase data, and/or current user session data for the users. The item recommendation computing device 102 trains the models based on their corresponding training data, and the item recommendation computing device 102 stores the models in a database, such as in the database 116 (e.g., a cloud storage).

The models, when executed by the item recommendation computing device 102, allow the item recommendation computing device 102 to determine item recommendations for one or more items to advertise to a customer. For example, the item recommendation computing device 102 may obtain the models from the database 116. The item recommendation computing device 102 may then receive, in real-time from the web server 104, current user session data identifying real-time events of the customer interacting with a website (e.g., viewing a webpage before or after placing a transaction order). In response to receiving the user session data, the item recommendation computing device 102 may execute the models to determine item recommendations for items to display to the customer. The user session data may identify actions (e.g., activity) of the customer on a website. For example, the user session data may identify item impressions, item clicks, items added to an online shopping cart, items purchased in an order, conversions, click-through rates, advertisements viewed, and/or advertisements clicked during an ongoing browsing session (e.g., the user data identifies real-time events).

In some examples, the item recommendation computing device 102 assigns the models (or parts thereof) for execution to one or more processing devices 120. For example, each model may be assigned to a virtual machine hosted by a processing device 120. The virtual machine may cause the models or parts thereof to execute on one or more processing units such as GPUs. In some examples, the virtual machines assign each model (or part thereof) among a plurality of processing units. Based on the output of the models, item recommendation computing device 102 may generate ranked item recommendations for items to be displayed on the website to a user.

In some examples, the recommended items are generated for a website based on a diversification-based explore-exploit model. Utilizing the user session data, the weights of a set of content elements associated with the website can be determined based on posterior distributions, e.g. Beta distributions, to maximize some business concerned metric, like CTR, A2C rate, conversion rate, etc. To increase recommendation diversity, the weights can be modified by at least one predetermined parameter to generate updated weights based on contextual feature data of the set of content elements. From the set of content elements, a ranked list of content elements may be generated to be displayed as recommended content on the website based on the updated weights of the set of content elements.

In some embodiments, each content element may be either a product item or a carousel including a plurality of items. A carousel may refer to a graphical and/or textual user interface, which is a website element that displays information with a set of items that one can slide, click, fade, or move into view.

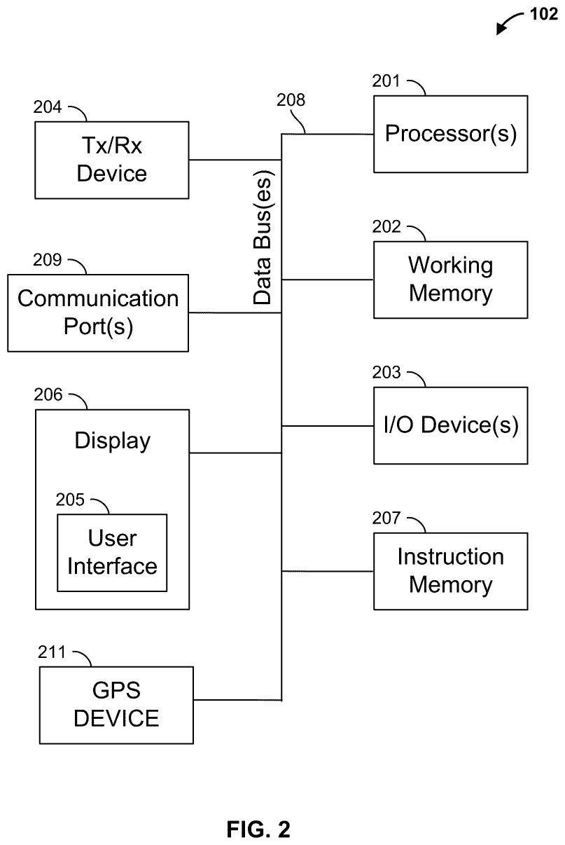

FIG. 2 illustrates a block diagram of an item recommendation computing device, e.g. the item recommendation computing device 102 of FIG. 1, in accordance with some embodiments of the present teaching. In some embodiments, each of the item recommendation computing device 102, the web server 104, the workstation(s) 106, the multiple customer computing devices 110, 112, 114, and the one or more processing devices 120 in FIG. 1 may include the features shown in FIG. 2. Although FIG. 2 is described with respect to the item recommendation computing device 102. It should be appreciated, however, that the elements described can be included, as applicable, in any of the item recommendation computing device 102, the web server 104, the workstation(s) 106, the multiple customer computing devices 110, 112, 114, and the one or more processing devices 120.

As shown in FIG. 2, the item recommendation computing device 102 can include one or more processors 201, a working memory 202, one or more input/output devices 203, an instruction memory 207, a transceiver 204, one or more communication ports 209, a display 206 with a user interface 205, and an optional global positioning system (GPS) device 211, all operatively coupled to one or more data buses 208. The data buses 208 allow for communication among the various devices. The data buses 208 can include wired, or wireless, communication channels.

The processors 201 can include one or more distinct processors, each having one or more cores. Each of the distinct processors can have the same or different structure. The processors 201 can include one or more central processing units (CPUs), one or more graphics processing units (GPUs), application specific integrated circuits (ASICs), digital signal processors (DSPs), and the like.

The instruction memory 207 can store instructions that can be accessed (e.g., read) and executed by the processors 201. For example, the instruction memory 207 can be a non-transitory, computer-readable storage medium such as a read-only memory (ROM), an electrically erasable programmable read-only memory (EEPROM), flash memory, a removable disk, CD-ROM, any non-volatile memory, or any other suitable memory. The processors 201 can be configured to perform a certain function or operation by executing code, stored on the instruction memory 207, embodying the function or operation. For example, the processors 201 can be configured to execute code stored in the instruction memory 207 to perform one or more of any function, method, or operation disclosed herein.

Additionally, the processors 201 can store data to, and read data from, the working memory 202. For example, the processors 201 can store a working set of instructions to the working memory 202, such as instructions loaded from the instruction memory 207. The processors 201 can also use the working memory 202 to store dynamic data created during the operation of the item recommendation computing device 102. The working memory 202 can be a random access memory (RAM) such as a static random access memory (SRAM) or dynamic random access memory (DRAM), or any other suitable memory.

The input-output devices 203 can include any suitable device that allows for data input or output. For example, the input-output devices 203 can include one or more of a keyboard, a touchpad, a mouse, a stylus, a touchscreen, a physical button, a speaker, a microphone, or any other suitable input or output device.

The communication port(s) 209 can include, for example, a serial port such as a universal asynchronous receiver/transmitter (UART) connection, a Universal Serial Bus (USB) connection, or any other suitable communication port or connection. In some examples, the communication port(s) 209 allows for the programming of executable instructions in the instruction memory 207. In some examples, the communication port(s) 209 allow for the transfer (e.g., uploading or downloading) of data, such as machine learning model training data.

The display 206 can be any suitable display, and may display the user interface 205. The user interfaces 205 can enable user interaction with the item recommendation computing device 102. For example, the user interface 205 can be a user interface for an application of a retailer that allows a customer to view and interact with a retailer's website. In some examples, a user can interact with the user interface 205 by engaging the input-output devices 203. In some examples, the display 206 can be a touchscreen, where the user interface 205 is displayed on the touchscreen.

The transceiver 204 allows for communication with a network, such as the communication network 118 of FIG. 1. For example, if the communication network 118 of FIG. 1 is a cellular network, the transceiver 204 is configured to allow communications with the cellular network. In some examples, the transceiver 204 is selected based on the type of the communication network 118 the item recommendation computing device 102 will be operating in. The processor(s) 201 is operable to receive data from, or send data to, a network, such as the communication network 118 of FIG. 1, via the transceiver 204.

The optional GPS device 211 may be communicatively coupled to the GPS and operable to receive position data from the GPS. For example, the GPS device 211 may receive position data identifying a latitude, and longitude, from a satellite of the GPS. Based on the position data, the item recommendation computing device 102 may determine a local geographical area (e.g., town, city, state, etc.) of its position. Based on the geographical area, the item recommendation computing device 102 may determine relevant trend data (e.g., trend data identifying events in the geographical area).

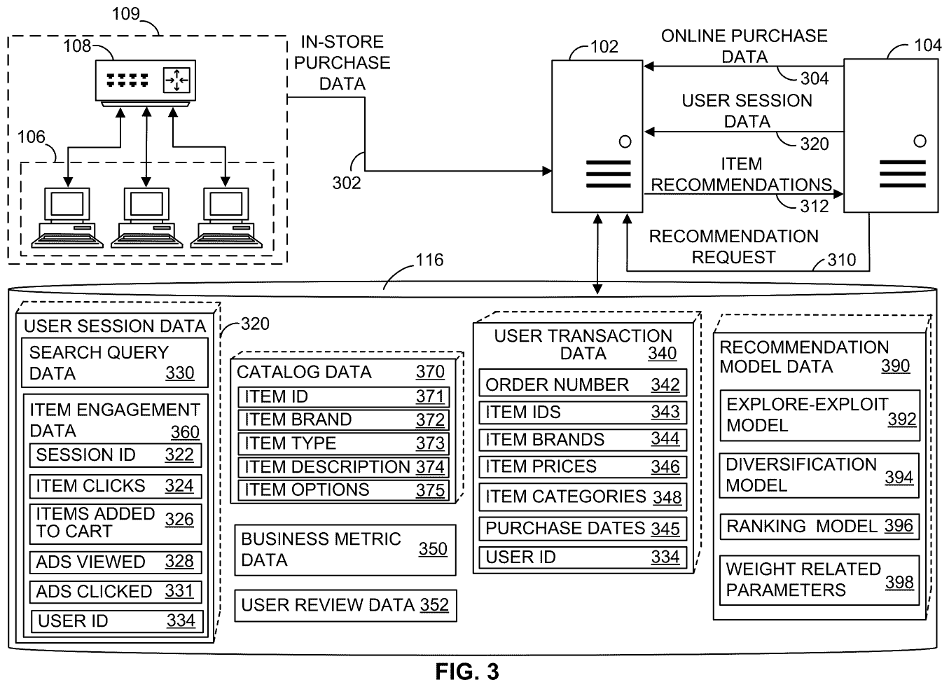

FIG. 3 is a block diagram illustrating various portions of an item recommendation system, e.g. the item recommendation system shown in the network environment 100 of FIG. 1, in accordance with some embodiments of the present teaching. As indicated in FIG. 3, the item recommendation computing device 102 may receive user session data 320 from the web server 104, and store the user session data 320 in the database 116. The user session data 320 may identify, for each user (e.g., customer), data related to that user's browsing session, such as when browsing a retailer's webpage hosted by the web server 104.

In some examples, the user session data 320 may include item engagement data 360 and/or search query data 330. The item engagement data 360 may include one or more of a session ID 322 (i.e., a website browsing session identifier), item clicks 324 identifying items which a user clicked (e.g., images of items for purchase, keywords to filter reviews for an item), items added-to-cart 326 identifying items added to the user's online shopping cart, advertisements viewed 328 identifying advertisements the user viewed during the browsing session, advertisements clicked 331 identifying advertisements the user clicked on, and user ID 334 (e.g., a customer ID, retailer website login ID, a cookie ID, etc.).

The search query data 330 may identify one or more searches conducted by a user during a browsing session (e.g., a current browsing session). For example, the item recommendation computing device 102 may receive a recommendation request 310 from the web server 104, where the recommendation request 310 may be associated with a search request that identifies one or more search terms provided by the user. The item recommendation computing device 102 may store the search terms as provided by the user as search query data 330.

The item recommendation computing device 102 may also receive online purchase data 304 from the web server 104, which identifies and characterizes one or more online purchases, such as purchases made by the user and other users via a retailer's website hosted by the web server 104. The item recommendation computing device 102 may also receive in-store purchase data 302 from the store 109, which identifies and characterizes one or more in-store purchases. In some embodiments, the in-store purchase data 302 may also indicate availability of items in the store 109, and/or user IDs that have selected the store 109 as a default store for picking up online orders.

The item recommendation computing device 102 may parse the in-store purchase data 302 and the online purchase data 304 to generate user transaction data 340. In this example, the user transaction data 340 may include, for each purchase, one or more of an order number 342 identifying a purchase order, item IDs 343 identifying one or more items purchased in the purchase order, item brands 344 identifying a brand for each item purchased, item prices 346 identifying the price of each item purchased, item categories 348 identifying a product type (e.g., category) of each item purchased, a purchase date 345 identifying the purchase date of the purchase order, and user ID 334 for the user making the corresponding purchase.

The database 116 may further store catalog data 370, which may identify one or more attributes of a plurality of items, such as a portion of or all items a retailer carries. The catalog data 370 may identify, for each of the plurality of items, an item ID 371 (e.g., an SKU number), item brand 372, item type 373 (e.g., grocery item such as milk, clothing item), item description 374 (e.g., a description of the product including product features, such as ingredients, benefits, use or consumption instructions, or any other suitable description), and item options 375 (e.g., item colors, sizes, flavors, etc.).

The database 116 may also store recommendation model data 390 identifying and characterizing one or more recommendation models and related data. For example, the recommendation model data 390 may include an explore-exploit model 392, a diversification model 394, a ranking model 396, and weight related parameters 398. The explore-exploit model 392 may be used to generate an initial list of items for recommendation, where each item in the initial list has an initial rank determined based on initial weights associated with the item. For example, the initial weights may be associated with posterior distributions determined based on the explore-exploit model 392 utilizing some of the user session data 320. The diversification model 394 may be used to increase diversification or diversity of recommended items, e.g. by modifying the initial weights with one or more of the weight related parameters 398. In some examples, the initial weights are modified based on contextual feature data of the items, e.g. price, product type, and review rating for the items. In some examples, the initial weights are further modified by a variance control parameter. Based on the explore-exploit model 392 and the diversification model 394, diversified and popular items may be selected for recommendation.

The ranking model 396 may be used to rank the selected items, e.g. based on their respective weights after the modification(s). In some embodiments, the initial weights and/or the modified weights may also be stored as part of the weight related parameters 398. A final ranked list of items may then be generated from the selected items, and transmitted as item recommendations 312 to the web server 104, to be displayed to the user.

In some examples, the database 116 may further store business metric data 350 and user review data 352. The business metric data 350 may identify data related to business defined metrics, including: e.g. click-through rate (CTR), add-to-cart (A2C) rate, conversion rate, etc. In some embodiments, the item recommendation computing device 102 may select one of the business defined metrics to optimize based on the explore-exploit model 392, and store the optimization data in the business metric data 350. The user review data 352 may identify user reviews of all users, including: e.g. review ratings and comments for reviewed items.

In some examples, the item recommendation computing device 102 receives (e.g., in real-time) the user session data 320 for a customer interacting with a website hosted by the web server 104. In response, the item recommendation computing device 102 generates item recommendations 312 identifying recommended items to advertise to the customer, and transmits the item recommendations 312 to the web server 104.

In some examples, the recommendation request 310 may be associated with an anchor item interacted by a user, e.g. an item clicked by the user to check a product description webpage of the item. In response, the item recommendation computing device 102 generates recommended items that are close to the anchor item as well as recommended items that are diversified with respect to the anchor item.

The item recommendation computing device 102 may rank the recommended items based on the ranking model 394. In some embodiments, one or more of the explore-exploit model 392, the diversification model 394 and the ranking model 396 are machine learning models (e.g. deep learning models) that are pre-trained before being stored in the database 116.

In some embodiments, the item recommendation computing device 102 may assign one or more of the above described operations to a different processing unit or virtual machine hosted by the one or more processing devices 120. Further, the item recommendation computing device 102 may obtain the outputs of the these assigned operations from the processing units, and generate the item recommendations 312 based on the outputs.

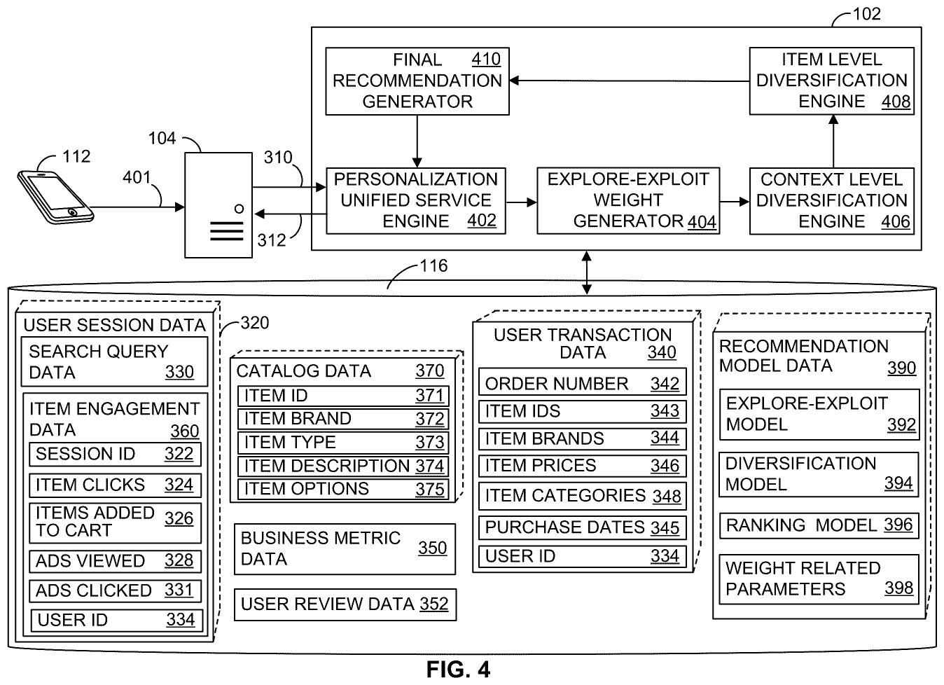

FIG. 4 is a block diagram illustrating a more detailed view of an item recommendation computing device, e.g. the item recommendation computing device 102 in FIG. 1, in accordance with some embodiments of the present teaching. As shown in FIG. 4, the item recommendation computing device 102 includes a personalization unified service engine 402, an explore-exploit weight generator 404, a context level diversification engine 406, an item level diversification engine 408, and a final recommendation generator 410. In some examples, one or more of the personalization unified service engine 402, the explore-exploit weight generator 404, the context level diversification engine 406, the item level diversification engine 408, and the final recommendation generator 410 are implemented in hardware. In some examples, one or more of the personalization unified service engine 402, the explore-exploit weight generator 404, the context level diversification engine 406, the item level diversification engine 408, and the final recommendation generator 410 are implemented as an executable program maintained in a tangible, non-transitory memory, such as instruction memory 207 of FIG. 2, which may be executed by one or processors, such as the processor 201 of FIG. 2.

For example, the personalization unified service engine 402 may obtain from the web server 104 a recommendation request 310 as a message 401 is sent from the user device 112 to the web server 104, and may execute recommendation model(s) included in the recommendation model data 390. The message 401 sent by the user using the user device 112 may indicate a search query or an anchor item interacted with by the user, or may just indicate a refresh of a webpage, e.g. a homepage of a website hosted by the web server 104. The recommendation request 310 may either include information about the anchor item, or indicate the anchor item in the user session data 320. In some embodiments, the recommendation request 310 is to seek one or more recommended items to be displayed on a webpage, which may be a home page of the website, a grocery page including grocery items, an item page including an anchor item described in the item page, or a promotion page including seasonal or holiday deals.

In this example, the web server 104 transmits a recommendation request 310 to the item recommendation computing device 102. The recommendation request 310 may include a request for item recommendations for presentation to a particular user using the user device 112. In some examples, the recommendation request 310 further identifies a user (e.g., customer) for whom the item recommendations are requested at the web server 104. The personalization unified service engine 402 receives the recommendation request 310, and receives and parses the user session data 320 (e.g., user session data associated with a current user session of the user in real-time). The personalization unified service engine 402 may provide to the explore-exploit weight generator 404 the user session data 320 and/or other data, which may include the user transaction data 340, the business metric data 350, and/or the user review data 352 extracted from the database 116.

In some embodiments, the explore-exploit weight generator 404 can obtain or collect various user interaction data with respect to a website hosted by the web server 104, including: the user session data 320 including data of the items added-to-cart 326, the user transaction data 340 including the user ID 334 and data about the purchased item, the user review data 352 identifying user reviews of different items, and the catalog data 370 including the item description data 374, either from the personalization unified service engine 402 or directly from the database 116.

In some examples, based on these collected data, the explore-exploit weight generator 404 can compute weights for a set of content elements associated with the website based on the explore-exploit model 392. The computed weights may be associated with posterior distributions for the content elements determined based on the explore-exploit model 392 utilizing the user session data. Each content element refers to an item for simplicity in the example of FIG. 4, although each content element may refer to an item and/or a carousel including a plurality of items in some embodiments. The explore-exploit weight generator 404 may send the computed weights to the context level diversification engine 406 for diversification improvement.

The context level diversification engine 406 can cluster items into different clusters based on their contextual feature data, which may include contextual features for each item, e.g. price, product type, or review rating. Within each cluster, the context level diversification engine 406 may modify the weights from the explore-exploit weight generator 404 by at least one predetermined parameter, e.g. a decay parameter to generate modified weights for each item. This cluster based modification may be performed based on one or more diversification models 394, and can increase a likelihood to recommend and display items from diversified clusters, thereby increasing recommendation diversity.

In addition, the context level diversification engine 406 can help to provide diversified recommendations based on a contextual feature like price, product type, or review rating. For example, when most of the items generated according to the computed weights from the explore-exploit weight generator 404 are around $100, the context level diversification engine 406 can help to increase a likelihood to recommend items in other price ranges, e.g. $200 or $50. In another example, an item has a one-star rating may not be bad, but because it is having very little exposure. As such, the item can still be recommended to a user together with some five-star and four-star rating items.

In some embodiments, the context level diversification engine 406 can increase diversification of the recommendations while keeping the optimization metric (e.g. CTR) above a certain threshold. The context level diversification engine 406 may send the modified weights to the item level diversification engine 408 for further diversification improvement.

In some embodiments, the item level diversification engine 408 may obtain the modified weights from the context level diversification engine 406, and re-modify the two modified weights by a variance control parameter to generate two updated weights for each item. This modification may be performed based on one or more diversification models 394, and can increase the variance of a posterior distribution associated with the weights, without changing the mean of the posterior distribution. The item level diversification engine 408 can help to improve diversification of the recommendation globally for all items, regardless of the contextual feature for each respective item.

In some embodiments, the item level diversification engine 408 can further increase diversification of the recommendations while keeping the optimization metric (e.g. CTR) above the certain threshold. That is, both the context level diversification engine 406 and the item level diversification engine 408 can improve diversification and discoverability, with limited cost of optimization capability. The item level diversification engine 408 may send the two updated weights to the final recommendation generator 410.

The final recommendation generator 410 in this example may obtain the updated weights from the item level diversification engine 408, and generate a ranked list of items based on a posterior distribution associated with the updated weights. The ranking of the items may be based on the updated weights according to the ranking model 396. The final recommendation generator 410 may generate the item recommendations 312 based on the ranked list of items, e.g. by selecting a plurality of top ranked items based on the ranking, and send the item recommendations 312 to the personalization unified service engine 402. Because diversification has been considered, the item recommendations 312 are not just top performing items in terms of one single metric, like CTR or conversion rate. Because a variance of the posterior distribution for each item has been increased by the item level diversification engine 408, when a user refreshes a webpage, it is likely to re-rank the items and provide different items in the item recommendations 312.

The personalization unified service engine 402 may receive the item recommendations 312 from the final recommendation generator 410 in a data format (e.g., message) acceptable by the web server 104. The personalization unified service engine 402 transmits the item recommendations 312 to web server 104. The web server 104 may then update or generate item recommendations for presentation to the user via the user device 112 based on the item recommendations 312. For example, the item recommendations may be displayed on a webpage showing a product description of the anchor item to the user, on a webpage showing search results including the anchor item to the user, on a webpage showing a shopping cart including the anchor item to the user, on a webpage showing an order of the anchor item placed by the user, and/or on a homepage of a website.

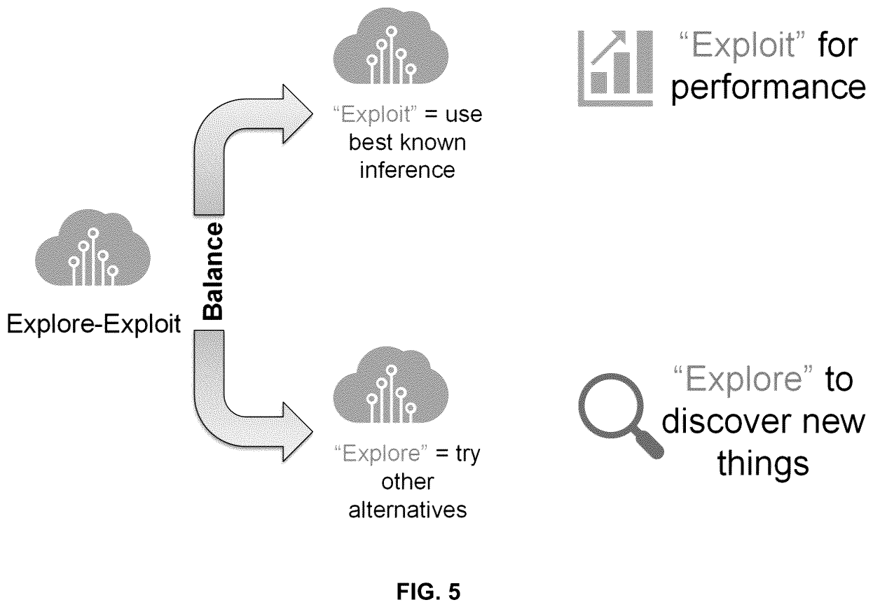

FIG. 5 illustrates a balance between explore and exploit in an explore-exploit model, in accordance with some embodiments of the present teaching. As shown in FIG. 5, an explore-exploit model has two goals at the same time. One goal is to exploit, to use best known inference. The other goal is to explore, to try other alternatives. While exploit is for improving performance, explore is for discovering new things. When a system has limited resources to invest, a good balance between exploit and explore is desired in many situations, including online item recommendation.

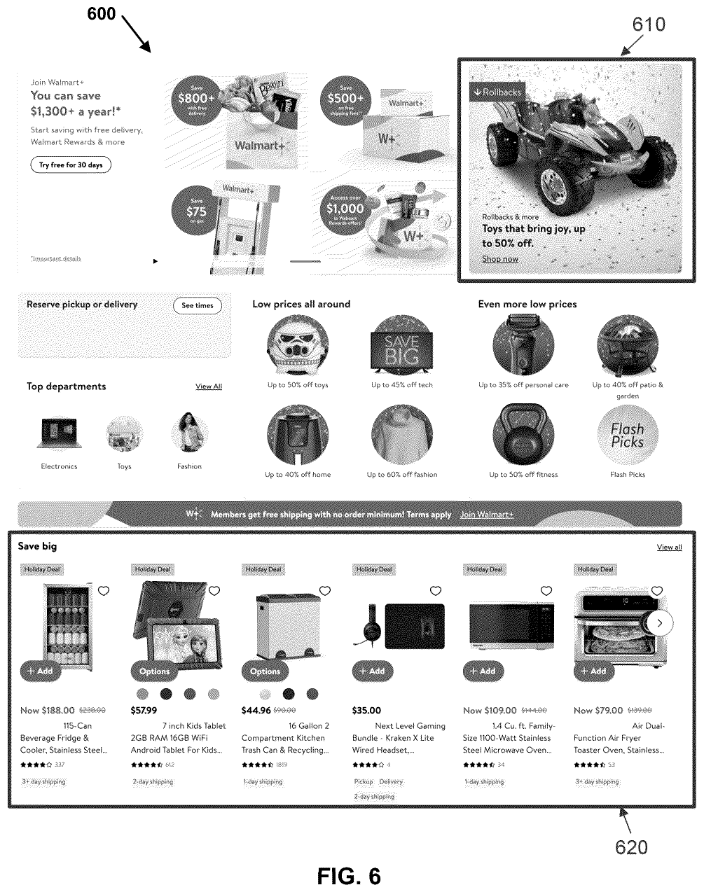

FIG. 6 illustrates an example of a homepage 600 including diversified item recommendations, in accordance with some embodiments of the present teaching. As shown in FIG. 6, a toy car 610 is displayed on the upper right hand side of the homepage. In some embodiments, the toy car 610 is selected from many potential items at back end. For example, after re-ranking about 60 items at the back end, the toy car 610 is determined to be very popular for past several hours or past several days.

In addition, a carousel 620 is displayed at the bottom of the homepage, e.g. based on carousel ranking. The carousel 620 is titled “save big” to display items with big discounts. For example, based on user interests during past several hours or past several days, the system may determine that users are more interested in the carousel 620 to save big money, compared to other carousels (e.g. about 20 carousels) at the back end, based on carousel ranking or re-ranking. In some embodiments, the six items shown in the carousel 620 may also be selected based on an item ranking performed by the system. The six items may be six top ranked items which the customers are most likely to engage with.

In some embodiments, when performing the ranking for items and/or carousels, the system may seek a balance between metric-based optimization and item diversification. For example, the ranking may try to optimize some metrics such as click through rate or add to cart rate, using Thompson sampling as a Bayesian approach, and to diversify recommended items by moving higher the ranks for some less exposed items and/or carousel.

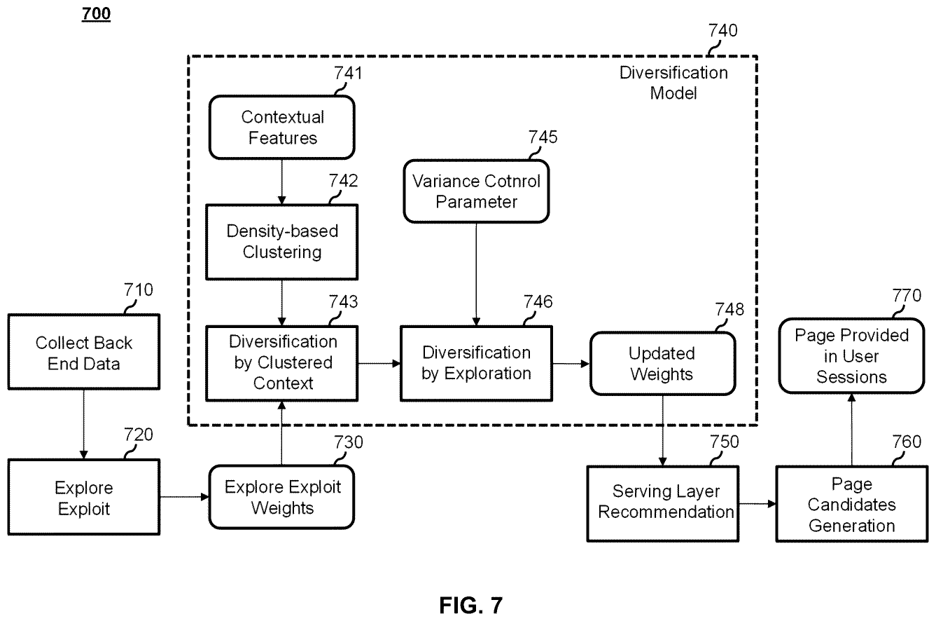

FIG. 7 illustrates a process 700 for providing diversified item recommendations, in accordance with some embodiments of the present teaching. In some embodiments, the process 700 may be carried out by one or more computing devices, such as the item recommendation computing device 102 and/or the cloud-based engine 121 of FIG. 1. As shown in FIG. 7, the process 700 starts from operation 710, where back end data are collected for item recommendation. For example, the item recommendation computing device 102 may receive from the web server 104 a recommendation request seeking recommendations to be displayed on a webpage of a website to a user, where the website is hosted by the web server 104. Based on the recommendation request, the item recommendation computing device 102 may collect back end data, which may include: user session data identifying website activities of users on the website, user transaction data identifying transactions of the users on the website, and/or catalog data identifying one or more attributes of items offered by the website.

Based on the collected data, an explore exploit model or algorithm may be performed at operation 720, to generate explore exploit weights 730 of a set of content elements associated with the website based on posterior distributions. In some embodiments, each content element is an item. In some embodiments, each content element is a carousel including a plurality of items. In some embodiments, the explore exploit model is performed at both item and carousel levels.

In some embodiments, the explore exploit model may utilize a Bayesian approach to sample numbers from a posterior distribution associated with the explore exploit weights 730, e.g. a beta distribution based on parameters α and β. In some embodiments, the beta distribution is a probability likelihood distribution of the true click-through-rate (CTR) of an item. For one item, each data point on the beta distribution (x, y) may represent that the probability of its true CTR at x is y.

In some embodiments, each item has its own α and β, where α represents a quantity of clicks for the item, and α+β represents a total impression for the item, within a given time period. The mean for the beta distribution is α/(α+β). In some embodiments, each real-time ranking may be determined based on the sampled numbers from different beta distributions (with different values of α and β) for different items. On average, the ranks for different items can be estimated or expected based on respective values of α/(α+β) corresponding to different items.

In some embodiments, the explore exploit weights 730 include α and β for different items. These explore exploit weights 730 may be determined to maximize a selected optimization metric, which is one of: click-through rate (CTR), add-to-cart (A2C) rate, or conversion rate.

In the example shown in FIG. 7, before sampling and ranking the items, the explore exploit weights 730 are sent to operation 740 for modification based on a diversification model. As shown in FIG. 7, the operation 740 includes an operation 743 for diversification by clustered context. In some embodiments, the operation 743 is based on operation 742, where the system can cluster, utilizing a density-based clustering model, the set of content elements into a plurality of clusters based on the contextual feature data 741 for each content element. Each of the plurality of clusters may include content elements whose quantity is above a predetermined threshold. For example, given the contextual feature Xᵢ for each item Yᵢ, where i∈{1, . . . , n}, some clustering model is used to cluster the items into clusters Cⱼ, where j∈{1, . . . , k}. The clustering model may utilize a density-based approach to ensure a minimum item count for each cluster Cⱼ. In some embodiments, the contextual feature data 741 includes contextual features for each content element; and the contextual features include information about at least one of: price, product type, or review rating.

At the operation 743, a rank may be determined for each content element in each cluster. The two weights β and β for each content element may be modified at the operation 743 based on the rank and a decay parameter, to generate two modified weights for each content element. In some embodiments, the two modified weights are generated to increase diversification of the recommendations while keeping the selected optimization metric above a certain threshold.

For example, the explore exploit weights β and β can be modified with a decay parameter λ with respect to an explore-exploit ranking in each cluster Cⱼ. In some examples, at the operation 743, the values of β and β for each item are modified based on the following equations:

$${α}_{m} = α * {λ}^{{ee}_{rank} - 1} \qquad ( 1 )$$

$${β}_{m} = β \qquad ( 2 )$$

where eeᵣₐₙₖ represents a rank for the item in a corresponding cluster. In some embodiments, eeᵣₐₙₖ can be computed based on α/(α+β).

In some embodiments, the decay parameter λ is predetermined and tunable, and can make the lower ranked items in each of the clusters less popular, such that other clusters will have more likelihood to be shown to the customer. For example, when λ=0.5, α for a lower ranked item (e.g. eeᵣₐₙₖ=6) in each cluster will shrink according to equation (1), and the expectation of eeᵣₐₙₖ (based on α/(α+β)) for the lower ranked item will become even smaller. As such, the lower ranked item in each cluster will become less popular. Therefore, it is less likely to select a lower ranked item in one cluster over a higher ranked item in another cluster. That is, the recommended items will come from diversified clusters. In various embodiments, λ may be predetermined to be 0.5, 0.75, 0.8, 0.9, etc., and updated based on a back end simulation process, which may be run every one or two hours.

In some embodiments, the operation 742 of density-based clustering may be performed in real-time, which means the operation 742 can be called by the operation 743 after receiving the explore exploit weights 730. In some embodiments, the operation 742 of density-based clustering may be performed periodically, e.g. every one or two hours, such that the operation 743 may be performed based on the latest clustering result from the operation 742, in response to each recommendation request.

In some embodiments, the modified explore exploit weights, e.g. the αₘ and βₘ, may be sent to the operation 746 for further modification. In some embodiments, the operation 746 is performed for diversification by exploration based on a variance control parameter 745. In some embodiments, for content elements within each of the plurality of clusters, the system can re-modify the two modified weights (αₘ and βₘ) for each content element by a variance control parameter to generate two updated weights for each content element. A posterior distribution for the content element after the re-modification has a same mean and a larger variance compared to a posterior distribution for the content element before the re-modification. In some embodiments, the two updated weights are generated to further increase diversification of the recommendations while keeping the selected optimization metric above the certain threshold.

In some examples, given the modified explore exploit weights (αₘᵢ, βₘᵢ) for each item Yᵢ, where i∈{1, . . . , n}, from the operation 743, the modified explore exploit weights can be further modified at the operation 746, with a variance control parameter Vₘ, based on the following equations:

$${α}_{new} = \frac{{α}_{mi}}{{α}_{mi} + {β}_{mi}} * {V}_{m} \qquad ( 3 )$$

$${β}_{new} = {V}_{m} - {α}_{new} \qquad ( 4 )$$

In some embodiments, the variance control parameter Vₘ may be predetermined based on analytical insights and/or business requirements, and can be updated using some back end simulation process, which may be run every one or two hours. With such modification at the operation 746, the posterior beta distribution remains the same mean for ranking, but with a larger variance. That is,

$$𝔼 ( Beta ( {α}_{mi} , {β}_{mi} ) ) = 𝔼 ( Beta ( {α}_{new} , {β}_{new} ) ) \qquad ( 5 )$$

$$Var ( Beta ( {α}_{mi} , {β}_{mi} ) ) ≪ Var ( Beta ( {α}_{new} , {β}_{new} ) ) \qquad ( 6 )$$

In some embodiments, the smaller the variance control parameter Vₘ is, the larger the variance is. Given a same CTR for an item, e.g. based on α/(α+β), a larger Vₘ means more impressions for the item, which also means more confidence and attention to the item. But paying too much attention to one item, e.g. due to a huge volume of impressions within a certain time, will decrease diversification for the recommendation, as less attention is paid to other items. The Vₘ may be controlled to be small, to lower the confidence and attention to the item (and every other item), such that more exploration is conducted for recommendation, and some of the unpopular items have a better chance to get exposures. In some examples, Vₘ=100 or 200.

As such, updated weights 748 are generated for ranking the items. At operation 750, the updated weights 748 are utilized to determine a layout for a webpage at a serving layer, e.g. by determining putting which item at which location of the webpage. At operation 760, page candidates are generated, e.g. based on the webpage layout. Each page candidate may correspond to a respective combination of different content elements (e.g. items and carousels) put into the webpage layout. Each block in the webpage layout may show a content element selected from many candidate content elements, e.g. based on a Bayesian algorithm with a random sampling from a posterior beta distribution with the updated weights 748 for each content element. For each user at a given time, one of page candidates is displayed to the user as the webpage.

Taking a homepage as an example, different users may see different versions of homepage including different recommended items at the same time. A same user may see different versions of homepage including different recommended items, after refreshing the homepage. In some examples, while different items correspond to different explore-exploit weights, they follow Beta distributions with different means and variances. A larger mean of a Beta distribution of a first item compared to a second item, may indicate that it is more likely to select the first item than the second item for recommendation on average. But the recommended item in each homepage displayed to a user may follow a random sampling of the Beta distributions. A larger variance of a Beta distribution for each item can increase diversification of the item recommendation, because an item following a Beta distribution with a small mean can still have a good chance to be selected for recommendation due to its increased variance.

In some embodiments, the weight related parameters, e.g. λ and Vₘ, are updated from time to time, e.g. every one or two hours. As such, a refresh of a webpage by a user after doing nothing online for one or two hours can expect a big change of the recommended items, due to the change of the weight related parameters and due to online activities of other users on the website during the one or two hours.

In some embodiments, a ranked list of content elements can be generated from the set of content elements at the operations 750 and 760. In some embodiments, the ranking for the set of content elements can be generated based on their respective two updated weights. For example, a rank for each item can be determined by sampling a Beta distribution with parameters (α_{new},β_{new}) as discussed above. Then a plurality of top content elements are selected from the set of content elements based on the ranking as the recommended content.

In some embodiments, the ranking may refer to an average ranking determined based on a mean of a respective Beta distribution for each item. In some embodiments, the ranking may refer to a real-time ranking determined based on a random sampling of a respective Beta distribution for each item.

In some embodiments, the recommended content is transmitted in response to the recommendation request. For example, the plurality of top content elements may be displayed in a webpage to a user. In some embodiments, the webpage includes at least one of: a home page of a website, a grocery page including grocery items, an item page including an anchor item, or a promotion page including seasonal or holiday deals. In some examples, the process 700 may be used to select and rank items from a large shelf of items to generate e.g. homepage, grocery page, or holiday deals. In some examples, the process 700 may be used to rank or re-rank items in a carousel, e.g. in an item page. In some examples, the process 700 may be used to rank and select carousels, from a pool of carousels, to be shown in a webpage e.g. homepage, grocery page.

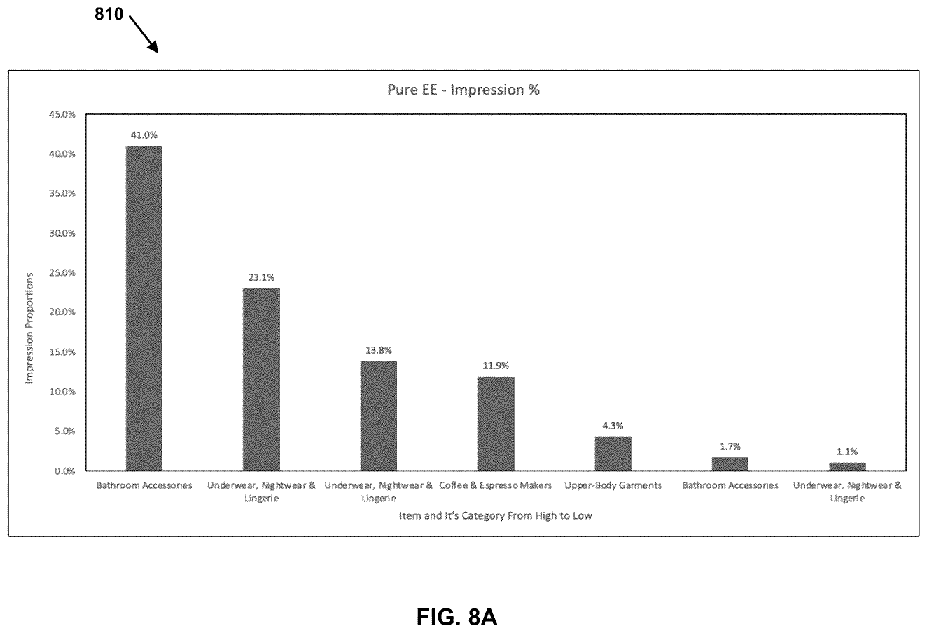

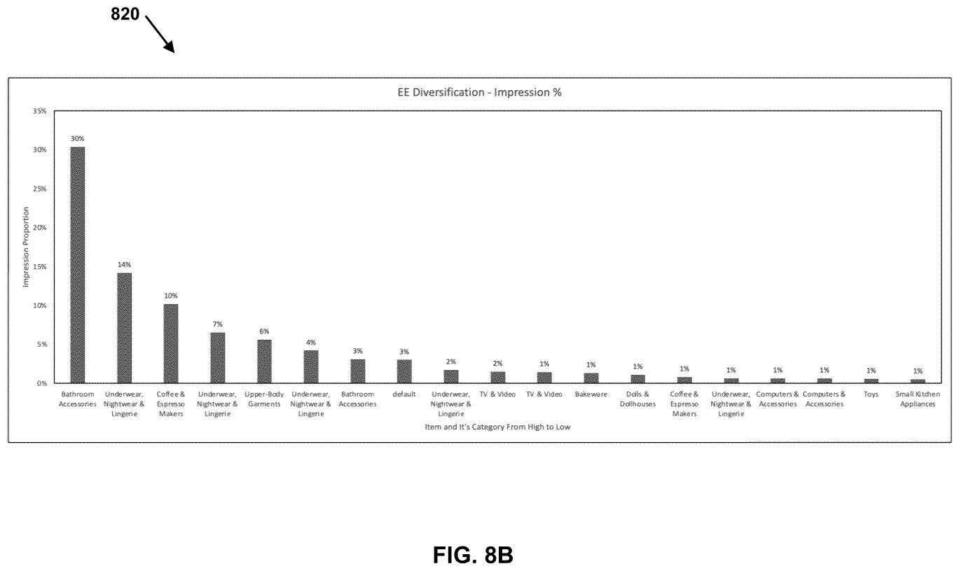

FIG. 8A illustrates a result 810 showing exemplary impression percentages for different item categories based on an explore-exploit model, in accordance with some embodiments of the present teaching. FIG. 8B illustrates a result 820 showing exemplary impression percentages for different item categories based on a diversification model, in accordance with some embodiments of the present teaching. As shown in FIG. 8A and FIG. 8B, compared to the result 810 for an explore-exploit model (e.g. the explore-exploit model performed at the operation 720), the result 820 for a diversification model (e.g. the diversification model performed at the operation 740) gives an evener distribution for impression percentages for different item categories. For example, the highest percentage in the result 820 is 30%, lower than the highest percentage 41% in the result 810. In contrast, the sixth highest percentage in the result 820 is 4%, higher than the sixth highest percentage 1.7% in the result 810. In addition, the order of different item categories in terms of impression percentages is also different between the results 810 and 820. For example, the category “Coffee & Espresso Makers” is ranked the fourth in the result 810, but is ranked the third in the result 820, in terms of impression percentages.

In some embodiments, the diversification model can be used when: item diversification is of top priority, dynamic user experience is anticipated, and a small cost on optimization is acceptable. The examples shown in FIG. 8A and FIG. 8B are for selecting an item to be displayed in a homepage. In one example, an item is selected out of about 80 items, based on either an explore-exploit model or a diversification model.

While the diversification model disclosed in the present teaching may also be called a diversified explore-exploit model, the original explore-exploit model may be called a pure explore-exploit model. As discussed above, the diversified explore-exploit model increases recommendation diversity compared to the pure explore-exploit model, with a metric loss below a certain threshold. In one example shown in FIG. 8A and FIG. 8B, the diversified explore-exploit model has an estimated CTR loss of 5%˜10%, compared to the pure explore-exploit model.

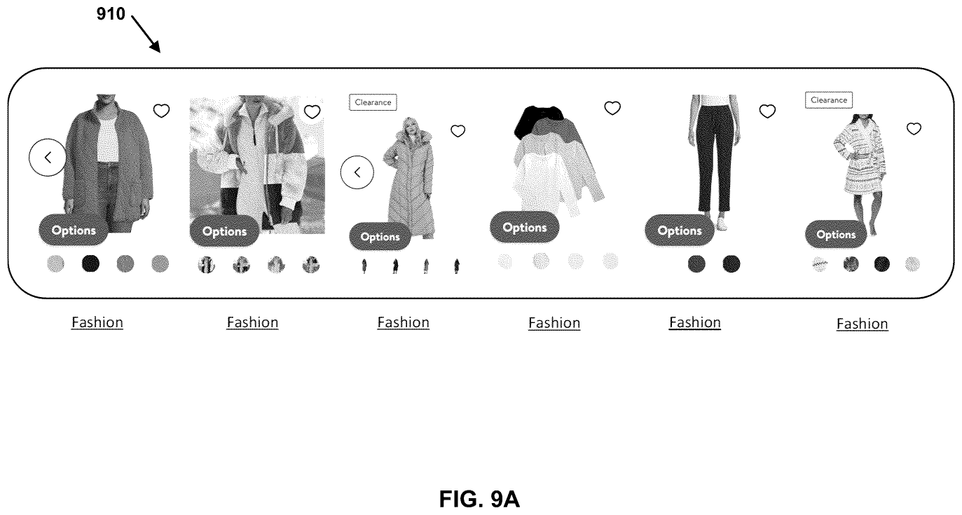

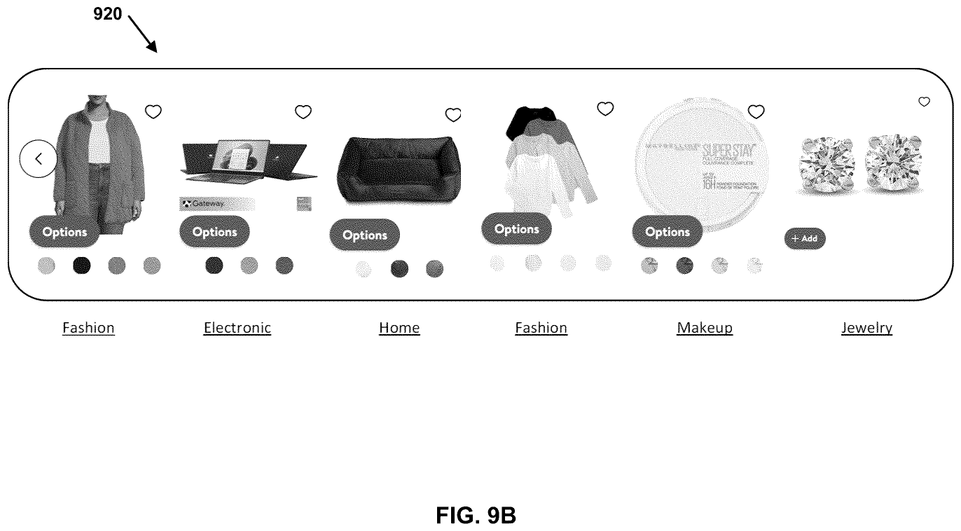

FIG. 9A illustrates an exemplary item recommendation 910 based on a pure explore-exploit model, in accordance with some embodiments of the present teaching. FIG. 9B illustrates an exemplary item recommendation 920 based on a diversified explore-exploit model, in accordance with some embodiments of the present teaching. As shown in the item recommendation 910 of FIG. 9A, the top six items selected according to the pure explore-exploit model are all from a same product type: Fashion. In contrast, as shown in the item recommendation 920 of FIG. 9B, the top six items selected according to the diversified explore-exploit model are from five different product types: Fashion, Electronic, Home, Makeup, and Jewelry. In addition, the diversified explore-exploit model can decrease the likelihood to recommend two similar items within a same product type. For example, according to a pure explore-exploit model, the top 6 ranked items out of 60 items in the Fashion category may be all underwear items. To increase diversity, the diversified explore-exploit model can decrease the likelihood to recommend all these underwear items in one recommendation. As such, the diversification improvement of the diversified explore-exploit model on both item level and product type level is significant, compared to the pure explore-exploit model.

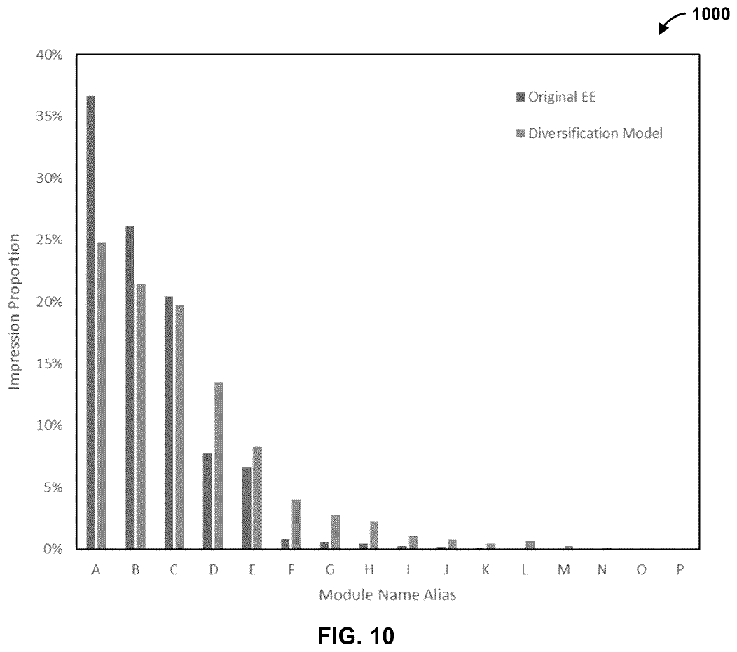

FIG. 10 illustrates a comparison result 1000 of exemplary impression percentages for different carousel modules based on an original or pure explore-exploit model and a diversification model (or diversified explore-exploit model), respectively, in accordance with some embodiments of the present teaching. While each carousel module is assigned a module name alias like A, B, C . . . , the comparison result 1000 shows different impression percentages for different carousel modules. As shown in FIG. 10, compared to the original explore-exploit model (e.g. the explore-exploit model performed at the operation 720), the diversification model (e.g. the diversification model performed at the operation 740) gives an evener distribution for impression percentages for different carousel modules.

In some embodiments, the diversification model can be used when: item diversification is of top priority, dynamic user experience is anticipated, and a small cost on optimization is acceptable. The example shown in FIG. 10 is for selecting a carousel to be displayed in a seasonal campaign. In one example, a carousel is selected out of about 20 carousels, based on either an explore-exploit model or a diversification model. In one example shown in FIG. 10, the diversification model (or diversified explore-exploit model) has an estimated CTR loss of ˜8%, compared to the original explore-exploit model.

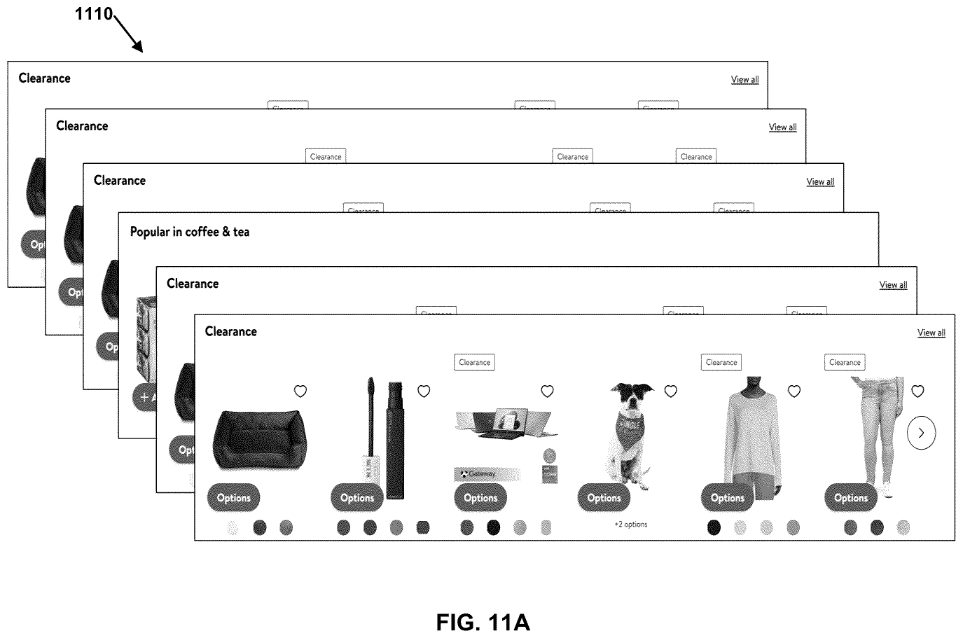

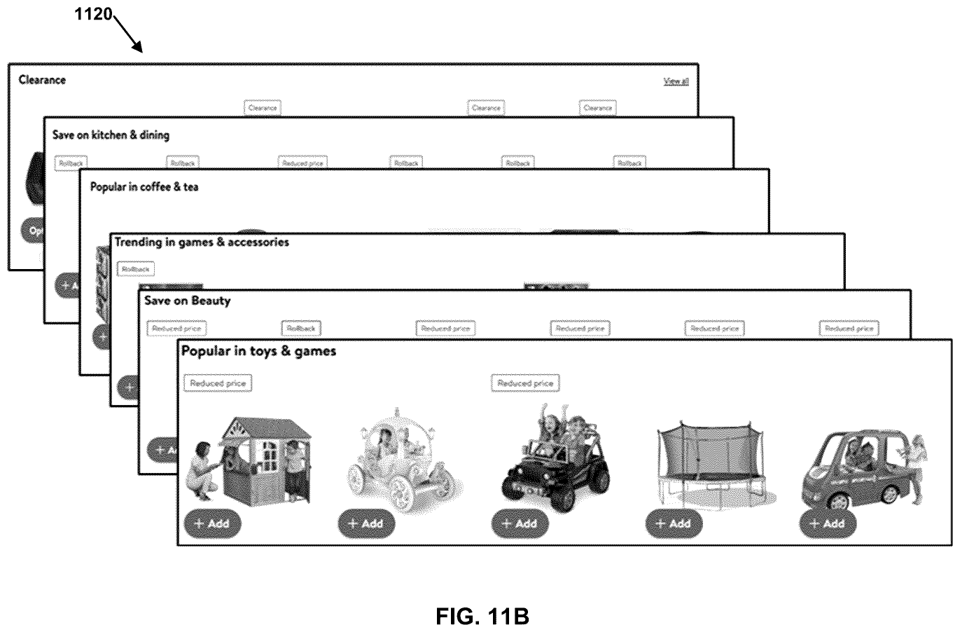

FIG. 11A illustrates exemplary recommended carousels 1110 based on an explore-exploit model, in accordance with some embodiments of the present teaching. In some examples, the recommended carousels 1110 are respectively shown in a webpage at different times based on the original explore-exploit model, as a user refreshes the webpage. As shown in FIG. 11A, within multiple user sessions, customers can only see a very limited number of carousels, and see the same carousel (e.g. Clearance as shown in FIG. 11A) repeatedly most of the time, when only the original explore-exploit model is used for item recommendation. In addition, carousels selected merely based on the original explore-exploit model may have the similar items from similar product types.

FIG. 11B illustrates exemplary recommended carousels 1120 based on a diversification model, in accordance with some embodiments of the present teaching. In some examples, the recommended carousels 1120 are respectively shown in a webpage at different times based on the diversified explore-exploit model, as a user refreshes the webpage. As shown in FIG. 11B, within multiple user sessions, customers are shown diverse carousels for better discoverability, when the diversified explore-exploit model is used for item recommendation. The carousels selected based on the diversified explore-exploit model are diversified to have items from different product types, e.g. Clearance, Save on kitchen & dining, Popular in coffee & tea, Trending in games & accessories, Save on Beauty, Popular in toys & games, as shown in FIG. 11B.

As such, the diversification improvement of the diversified explore-exploit model on carousel level is significant, compared to the pure explore-exploit model. In one example, more than 35% of the time only one carousel was shown with the pure explore-exploit model, and the same percentage decreases down to 25% with the diversified explore-exploit model.

In some embodiments, the diversification improvement can be pursued at both item level and carousel level. For example, while one carousel (e.g. Clearance) is selected from diversified carousel types as shown in FIG. 11B, the items in the selected carousel are also selected from diversified product types as shown in FIG. 9B.

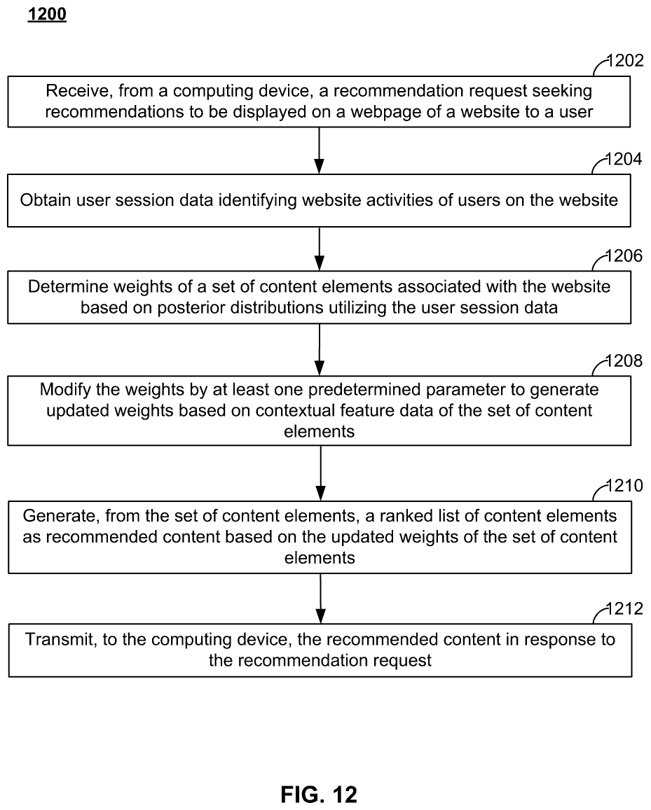

FIG. 12 is a flowchart illustrating an exemplary method 1200 for improving diversification in online item recommendations, in accordance with some embodiments of the present teaching. In some embodiments, the method 1200 can be carried out by one or more computing devices, such as the item recommendation computing device 102 and/or the cloud-based engine 121 of FIG. 1. Beginning at operation 1202, a recommendation request is received from a computing device, to seek recommendations to be displayed on a webpage of a website to a user. At operation 1204, user session data is obtained to identify website activities of users on the website. At operation 1206, weights of a set of content elements associated with the website are determined based on posterior distributions utilizing the user session data. The weights are modified at operation 1208 by at least one predetermined parameter to generate updated weights based on contextual feature data of the set of content elements. A ranked list of content elements is generated at operation 1210 from the set of content elements as recommended content based on the updated weights of the set of content elements. At operation 1212, the recommended content is transmitted to the computing device in response to the recommendation request.

Although the methods described above are with reference to the illustrated flowcharts, it will be appreciated that many other ways of performing the acts associated with the methods can be used. For example, the order of some operations may be changed, and some of the operations described may be optional.

In addition, the methods and system described herein can be at least partially embodied in the form of computer-implemented processes and apparatus for practicing those processes. The disclosed methods may also be at least partially embodied in the form of tangible, non-transitory machine-readable storage media encoded with computer program code. For example, the steps of the methods can be embodied in hardware, in executable instructions executed by a processor (e.g., software), or a combination of the two. The media may include, for example, RAMs, ROMs, CD-ROMs, DVD-ROMs, BD-ROMs, hard disk drives, flash memories, or any other non-transitory machine-readable storage medium. When the computer program code is loaded into and executed by a computer, the computer becomes an apparatus for practicing the method. The methods may also be at least partially embodied in the form of a computer into which computer program code is loaded or executed, such that, the computer becomes a special purpose computer for practicing the methods. When implemented on a general-purpose processor, the computer program code segments configure the processor to create specific logic circuits. The methods may alternatively be at least partially embodied in application specific integrated circuits for performing the methods.

Each functional component described herein can be implemented in computer hardware, in program code, and/or in one or more computing systems executing such program code as is known in the art. As discussed above with respect to FIG. 2, such a computing system can include one or more processing units which execute processor-executable program code stored in a memory system. Similarly, each of the disclosed methods and other processes described herein can be executed using any suitable combination of hardware and software. Software program code embodying these processes can be stored by any non-transitory tangible medium, as discussed above with respect to FIG. 2.

The foregoing is provided for purposes of illustrating, explaining, and describing embodiments of these disclosures. Modifications and adaptations to these embodiments will be apparent to those skilled in the art and may be made without departing from the scope or spirit of these disclosures. Although the subject matter has been described in terms of exemplary embodiments, it is not limited thereto. Rather, the appended claims should be construed broadly, to include other variants and embodiments, which can be made by those skilled in the art.

What is claimed is:

1. A system, comprising:
a non-transitory memory having instructions stored thereon; and
at least one processor operatively coupled to the non-transitory memory, and configured to read the instructions to:
receive, from a computing device, a recommendation request seeking recommendations to be displayed on a webpage of a website to a user,
obtain user session data identifying website activities of users on the website,
determine weights of a set of content elements associated with the website based on posterior distributions utilizing the user session data,
modify the weights by at least one predetermined parameter to generate updated weights based on contextual feature data of the set of content elements,
generate, from the set of content elements, a ranked list of content elements as recommended content based on the updated weights of the set of content elements, and
transmit, to the computing device, the recommended content in response to the recommendation request.

2. The system of claim 1, wherein:
the computing device is associated with a web server hosting the website;
each content element is an item or a carousel including a plurality of items; and
the webpage includes at least one of: a home page of the website, a grocery page including grocery items, an item page including an anchor item, or a promotion page including seasonal or holiday deals.

3. The system of claim 1, wherein:
the weights are determined based on an explore-exploit model to maximize a selected optimization metric, which is one of: click-through rate (CTR), add-to-cart (A2C) rate, or conversion rate.

4. The system of claim 3, wherein the updated weights are generated based on:
clustering, utilizing a density-based clustering model, the set of content elements into a plurality of clusters based on the contextual feature data for each content element, wherein each of the plurality of clusters includes content elements whose quantity is above a predetermined threshold; and
for content elements within each of the plurality of clusters,
determining a rank for each content element in the cluster, and
modifying two weights for each content element based on the rank and a decay parameter, to generate two modified weights for each content element.

5. The system of claim 4, wherein:
the contextual feature data includes contextual features for each content element; and
the contextual features include information about at least one of: price, product type, or review rating.

6. The system of claim 4, wherein:
the two modified weights are generated to increase diversification of the recommendations while keeping the selected optimization metric above a certain threshold.

7. The system of claim 6, wherein the updated weights are generated further based on:
for content elements within each of the plurality of clusters, re-modifying the two modified weights for each content element by a variance control parameter to generate two updated weights for each content element.

8. The system of claim 7, wherein:
a posterior distribution for the content element after the re-modification has a same mean and a larger variance compared to a posterior distribution for the content element before the re-modification; and
the two updated weights are generated to further increase diversification of the recommendations while keeping the selected optimization metric above the certain threshold.

9. The system of claim 7, wherein the ranked list of content elements is generated based on:
generating a ranking for the set of content elements based on their respective two updated weights; and
selecting a plurality of top content elements in the set of content elements based on the ranking as the recommended content.

10. A computer-implemented method, comprising:
receiving, from a computing device, a recommendation request seeking recommendations to be displayed on a webpage of a website to a user;
obtaining user session data identifying website activities of users on the website;
determining weights of a set of content elements associated with the website based on posterior distributions utilizing the user session data;
modifying the weights by at least one predetermined parameter to generate updated weights based on contextual feature data of the set of content elements;
generating, from the set of content elements, a ranked list of content elements as recommended content based on the updated weights of the set of content elements; and
transmitting, to the computing device, the recommended content in response to the recommendation request.

11. The computer-implemented method of claim 10, wherein:
the weights are determined based on an explore-exploit model to maximize a selected optimization metric, which is one of: click-through rate (CTR), add-to-cart (A2C) rate, or conversion rate.

12. The computer-implemented method of claim 11, wherein the updated weights are generated based on:
clustering, utilizing a density-based clustering model, the set of content elements into a plurality of clusters based on the contextual feature data for each content element, wherein each of the plurality of clusters includes content elements whose quantity is above a predetermined threshold; and
for content elements within each of the plurality of clusters,
determining a rank for each content element in the cluster, and
modifying two weights for each content element based on the rank and a decay parameter, to generate two modified weights for each content element.

13. The computer-implemented method of claim 12, wherein:
the two modified weights are generated to increase diversification of the recommendations while keeping the selected optimization metric above a certain threshold.

14. The computer-implemented method of claim 13, wherein the updated weights are generated further based on:
for content elements within each of the plurality of clusters, re-modifying the two modified weights for each content element by a variance control parameter to generate two updated weights for each content element.

15. The computer-implemented method of claim 14, wherein:
a posterior distribution for the content element after the re-modification has a same mean and a larger variance compared to a posterior distribution for the content element before the re-modification; and
the two updated weights are generated to further increase diversification of the recommendations while keeping the selected optimization metric above the certain threshold.

16. A non-transitory computer readable medium having instructions stored thereon, wherein the instructions, when executed by at least one processor, cause at least one device to perform operations comprising:
receiving, from a computing device, a recommendation request seeking recommendations to be displayed on a webpage of a website to a user;
obtaining user session data identifying website activities of users on the website;
determining weights of a set of content elements associated with the website based on posterior distributions utilizing the user session data;
modifying the weights by at least one predetermined parameter to generate updated weights based on contextual feature data of the set of content elements;
generating, from the set of content elements, a ranked list of content elements as recommended content based on the updated weights of the set of content elements; and
transmitting, to the computing device, the recommended content in response to the recommendation request.

17. The non-transitory computer readable medium of claim 16, wherein:
the weights are determined based on an explore-exploit model to maximize a selected optimization metric, which is one of: click-through rate (CTR), add-to-cart (A2C) rate, or conversion rate.

18. The non-transitory computer readable medium of claim 17, wherein the updated weights are generated based on:
clustering, utilizing a density-based clustering model, the set of content elements into a plurality of clusters based on the contextual feature data for each content element, wherein each of the plurality of clusters includes content elements whose quantity is above a predetermined threshold; and
for content elements within each of the plurality of clusters,
determining a rank for each content element in the cluster, and
modifying two weights for each content element based on the rank and a decay parameter, to generate two modified weights for each content element, wherein the two modified weights are generated to increase diversification of the recommendations while keeping the selected optimization metric above a certain threshold.

19. The non-transitory computer readable medium of claim 18, wherein the updated weights are generated further based on:
for content elements within each of the plurality of clusters, re-modifying the two modified weights for each content element by a variance control parameter to generate two updated weights for each content element.

20. The non-transitory computer readable medium of claim 19, wherein:
a posterior distribution for the content element after the re-modification has a same mean and a larger variance compared to a posterior distribution for the content element before the re-modification; and
the two updated weights are generated to further increase diversification of the recommendations while keeping the selected optimization metric above the certain threshold.
